(19) United States
(12) Patent Application Publication
(10) Pub. No.: US 2024/0127056 A1
(43) Pub. Date: Apr. 18, 2024

(54) COMPUTATIONAL STORAGE FOR AN ENERGY-EFFICIENT DEEP NEURAL NETWORK TRAINING SYSTEM

(71) Applicant: SK hynix Inc., Gyeonggi-do (KR)

(72) Inventors: Jongryool KIM, San Jose, CA (US); Hyung Jin LIM, San Jose, CA (US); Kevin TANG, San Jose, CA (US); Shiju LI, San Jose, CA (US)

(21) Appl. No.: 18/457,171

(22) Filed: Aug. 28, 2023

Related U.S. Application Data
(60) Provisional application No. 63/415,476, filed on Oct. 12, 2022.

(51) Int. Cl. G06N 3/08; G06F 3/06; G06N 3/044

(52) U.S. Cl. CPC G06N 3/08; G06F 3/0625; G06F 3/0656; G06F 3/0673; G06N 3/044

(57) ABSTRACT

A training system includes a dynamic random access memory (DRAM) configured to buffer training data; a central processing unit (CPU) coupled to the DRAM and configured to downsample the training data and provide the DRAM with the downsampled training data; a computational storage consisting of a solid-state drive (SSD) and field-programmable gate array (FPGA) and configured to perform dimensionality reduction on the downsampled training data to generate training data batches; and a graphic processing unit (GPU) configured to perform training on the training data batches.

### CROSS-REFERENCE TO RELATED APPLICATION

This application claims the benefit of U.S. Provisional Patent Application No. 63/415,476, filed on Oct. 12, 2022, the entire contents of which are incorporated herein by reference.

### BACKGROUND

### 1. Field

Embodiments of the present disclosure relate to a scheme of processing data in deep neural networks.

### 2. Description of the Related Art

Deep neural networks (DNNs) have played a pivotal role in numerous domains such as computer vision, natural language processing, biomedical analysis and robotics. However, their development and deployment present challenges. When training a DNN model on a large dataset or a dataset containing high dimensional data, storing all the training data in graphic processing units (GPUs) can become impractical due to the limited memory capacity of GPUs, leading to out-of-memory errors and thus preventing further training. To overcome this issue, one can access the data in smaller, buffered chunks by partitioning the data. Nonetheless, even with data partitioning, there are still limitations due to relatively lower memory performance growth.

The speed at which data can be read from memory is slower than the speed at which data can be processed in GPUs, which makes accessing data from memory a bottleneck. This can slow down the training process and potentially cause issues with model convergence. This bottleneck is further compounded when multiple epochs of training are required or when hyperparameter tuning is necessary. In such cases, the same data must be repeatedly accessed, leading to even slower storage access and exacerbating the performance bottleneck. This is known as the “GPU memory capacity wall”. As the size of the dataset and the complexity of the DNN model increase, the amount of memory required to store the data also goes up.

To cope with the memory problem associated with training a DNN model, one common approach has been to distribute the training of each model across multiple GPUs. A unified architecture for accelerating distributed DNN training in heterogeneous GPU/CPU clusters has been considered. This approach involves splitting the dataset or model variables across the GPUs, resulting in faster training time and improved performance. However, it can lead to a linear increase in GPU and energy costs. Another recent approach is to take advantage of the host central processing unit (CPU) memory as a buffer to offload some of the impending tensors during training.

In this context, the embodiments of the present invention arise.

### SUMMARY

Aspects of the present invention include a scheme to enhance the performance and energy efficiency of a training system such as deep neural networks.

In one aspect, a training system includes a dynamic random access memory (DRAM) configured to buffer training data; a central processing unit (CPU) coupled to the DRAM and configured to downsample the training data and provide the DRAM with the downsampled training data; a computational storage consisting of a solid-state drive (SSD) and field-programmable gate array (FPGA) and configured to perform dimensionality reduction on the downsampled training data to generate training data batches; and a graphic processing unit (GPU) configured to perform training on the training data batches.

In another aspect, a method for operating a training system includes buffering, by a dynamic random access memory (DRAM), training data; downsampling, by a central processing unit (CPU) coupled to the DRAM, the training data to provide the DRAM with the downsampled training data; performing, by a computational storage coupled to the DRAM, dimensionality reduction on the downsampled training data to generate training data batches; and performing, by a graphic processing unit (GPU), training on the training data batches.

Additional aspects of the present invention will become apparent from the following description.

### BRIEF DESCRIPTION OF THE DRAWINGS

FIG. 1A is a diagram illustrating a DRAM-buffered DNN training system.

FIG. 1B is a diagram illustrating a storage-buffered DNN training system.

FIG. 2 is a diagram illustrating a computational storage-buffered training system in accordance with one embodiment of the present invention.

FIG. 3 is a diagram illustrating a compute unit in accordance with another embodiment of the present invention.

FIG. 4 is a diagram illustrating a tiled data format in accordance with another embodiment of the present invention.

FIG. 5 is a diagram illustrating computational storage prototype and training system testbed in accordance with another embodiment of the present invention.

FIG. 6 is a flowchart illustrating an operation of a computational storage-buffered training system in accordance with another embodiment of the present invention.

FIG. 7 is a diagram illustrating a workflow for unconstrained scene text recognition in accordance with another embodiment of the present invention.

FIG. 8 is a diagram illustrating CNN model training in CDRNN in accordance with another embodiment of the present invention.

FIG. 9 illustrates test datasets used for testing a training system in accordance with another embodiment of the present invention.

FIG. 10 illustrates a workflow of CDRNN in accordance with another embodiment of the present invention.

FIGS. 11A to 11C illustrate runtime of different workloads for various training systems.

FIGS. 12A to 12C illustrate workload performance comparison for various training systems.

FIGS. 13A to 13C illustrate workload performance comparison under different batch sizes for various training systems.

FIG. 14 illustrates accuracy of model with different training data sizes and workloads.

FIG. 15 illustrates an example of model prediction results.

FIG. 16 illustrates RP phase comparison.

FIG. 17 illustrates a comparison of average power and energy consumption for different number of training sample with all workloads.

FIG. 18 illustrates runtime of workloads with different training data sizes for various training systems.

### DETAILED DESCRIPTION

Various embodiments of the present disclosure are described below in more detail with reference to the accompanying drawings. The present disclosure may, however, be embodied in different forms and thus should not be construed as limited to the embodiments set forth herein. Rather, these embodiments are provided so that this disclosure conveys the scope of the present disclosure to those skilled in the art. Moreover, reference herein to “an embodiment,” “another embodiment,” or the like is not necessarily to only one embodiment, and different references to any such phrase are not necessarily to the same embodiment(s). The term “embodiments” as used herein does not necessarily refer to all embodiments. Throughout the disclosure, like reference numerals refer to like parts in the figures and the detailed embodiments.

The present disclosure can be implemented in numerous ways, including such as for example a process; an apparatus; a system; a computer program product embodied on a computer-readable storage medium; and/or a processor, such as a processor suitable for executing instructions stored on and/or provided by a memory coupled to the processor. In this specification, these implementations, or any other form that the present invention may take, may be referred to as techniques. In general, the order of the operations of the disclosed processes may be altered within the scope of the present invention. Unless stated otherwise, a component such as a processor or a memory described as being suitable for performing a task may be implemented as a general device or circuit component that is configured or otherwise programmed to perform the task at a given time or as a specific device or as a circuit component that is manufactured or pre-configured or pre-programmed to perform the task. As used herein, the term ‘processor’ or the like refers to one or more devices, circuits, and/or processing cores suitable for processing data, such as computer program instructions.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described herein, the code or instructions for implementing the operations of the method embodiments may transform the computer, processor, controller, or other signal processing device into a special-purpose processor for performing any one of the methods herein.

If implemented at least partially in software, the controllers, processors, devices, modules, units, multiplexers, generators, logic, interfaces, decoders, drivers, generators and other signal generating and signal processing features may include, for example, a memory or other storage device for storing code or instructions to be executed, for example, by a computer, processor, microprocessor, controller, or other signal processing device.

A detailed description of various embodiments of the present invention is provided below along with accompanying FIGS. that illustrate aspects of the present disclosure. The present disclosure is described in connection with such embodiments, but the present disclosure is not limited to any specific embodiment. The present disclosure encompasses numerous alternatives, modifications and equivalents of the disclosed embodiments. Numerous specific details are set forth in the following description in order to provide a thorough understanding of the present disclosure. These details are provided for the purpose of example; the present invention may be practiced without some or all of these specific details described herein. For clarity, technical material that is known in technical fields related to the present disclosure has not been described in detail so that the invention is not unnecessarily obscured.

The approach (noted above) of utilizing the host central processing unit (CPU) memory as a buffer to offload some of the impending tensors during training can in practice (as recognized by the inventors) result in low training throughput and significant CPU memory interference. To address the low training throughput and the significant CPU memory interference and to relieve the burden of utilizing the CPU during training, the present disclosure in one embodiment, instead of addressing at a hardware level the issues regarding the time to read the memory, provides an orthogonal approach which preprocesses the training data in a way that accelerates the model training while mitigating the issues with the time to read data from the memory.

Table 1 provides definitions of several abbreviations used in the specification.

TABLE1
API: Application Programming Interface
BRAM: Block Random Access Memory
CDRNN: Convolutional Dimensionality-reduced Recurrent Neural
Network
CDRNN: Convolutional Recurrent Neural Network
CNN: Convolutional Neural Network
CPU: Central Processing Unit
CS: Computational Storage
CTC: Connectionist Temporal Classification
CU: Compute Unit or Computing Unit
DNN: Deep Neural Network
DSP: Digital Signal Processor
DR: Dimensionality Reduction
DRAM: Dynamic Random Access Memory
FPGA: Field Programmable Gate Array
GPU: Graphic Processing Unit
HLS: High-Level Synthesis
MLP: Multilayer Perceptron
DMA: Direct Memory Access
P2P-DMA: Peer-to-Peer Direct Memory Access
RNN: Recurrent Neural Network
RP: Random Protection
SGEMM: Single Precision General Matrix Multiply
SSD: Solid State Drive
XRT: Xilinx Runtime

In accordance with various embodiments of the present disclosure, there is provided a computational-storage system (referred to hereinafter as the inventive training system) which provides accelerated data preprocessing for DNN training by performing data preprocessing steps (for example RP) in a computational storage near the SSD to minimize overall data movement. As detailed below, utilizing computational storage near the SSD achieves low end-to-end latency and high energy efficiency. In one embodiment of the present disclosure, the inventive training system can reduce the training time and improve the accuracy of the DNN model, which not only addresses the issues regarding the time to read the memory during DNN training but also ensures lower energy consumption.

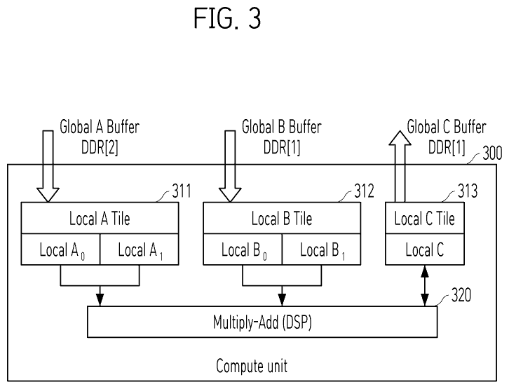

Embodiments of the present disclosure provide the following contributions:
(1) These embodiments of the inventive training system provide a computational storage that accelerates data preprocessing for AI training by integrating dimensionality reduction into a computational component inside the computational storage (e.g., inside compute unit 300 in FIG. 3). As used herein, “dimensionality reduction” refers to techniques for reducing the dimensions of a data feature set by extracting from the data set a subset having the most relevant or prominent features, thereby preserving the essence of the original data feature set.
(2) As detailed below, this computational storage can be used with general DNN models such as MLP to reduce training time and energy consumption. Experimental results (detailed below) on real-world datasets show a clear difference in training time between workloads with and without this computational storage that accelerates data preprocessing for AI training by integrating dimensionality reduction into a computational component inside the computational storage. Using this computational storage instead of a CPU for dimensionality reduction can reduce energy consumption and can improve model accuracy especially for relatively large datasets.
(3) To utilize the near-storage data preprocessing function for computational storage, the present disclosure provides an inventive training system that supports large dataset DNN training, which can improve the performance of a continuous time recurrent neural network CRNN model in for example text recognition. Further, experimental results on training large datasets show distinct benefits with RP compared to without RP. Performing RP using this computational storage (that accelerates data preprocessing for AI training by integrating dimensionality reduction into a computational component inside the computational storage) can achieve similar accuracy to the CRNN model while ensuring low end-to-end latency and high-energy efficiency.

A. Computational Storage for DNN Prepossessing

A training system may be implemented with a DRAM buffered DNN training system or a storage buffered DNN training system.

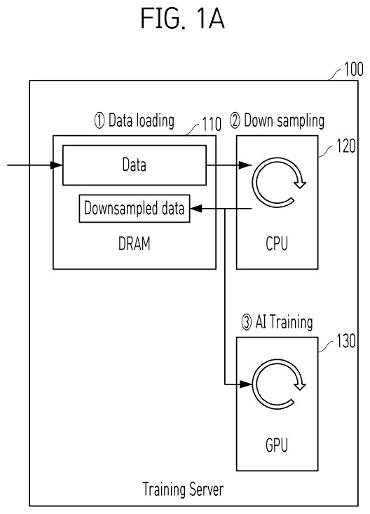

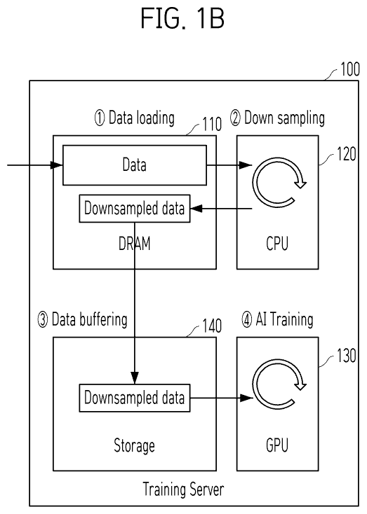

A DRAM-buffered DNN training system may comprise three operations: data loading (\textcircled{1}), downsampling (\textcircled{2}) and DNN (or AI) training (\textcircled{3}). As shown in FIG. 1A, assuming that a data source is outside a training server 100 (e.g., at a host), the general DNN training process usually buffers the data in DRAM 110, downsamples it by CPU 120, and loads it to GPU 130 during training. If the input data for training is larger than the GPU memory, the GPU 130 reads the data from DRAM 110 during training to load the entire data batch from DRAM 110 to GPU memory during each training epoch.

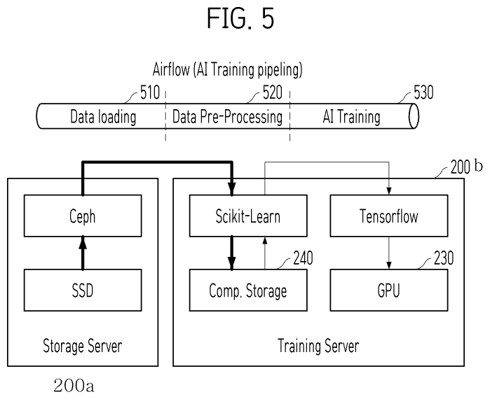

For large-dataset DNN training, a local storage may be used to buffer the training data since the input data is too large to fit into DRAM 110. As shown in FIG. 1B, the original data (\textcircled{1}) is first transmitted from the objective storage (e.g., SSD of FIG. 5) to the DRAM 110. Then, the data is partitioned, downsampled by the CPU 120 (\textcircled{2}), and buffered into the local storage 140 (\textcircled{3}). The buffered data will be read as multiple training batches by a training batch generator during training, and finally fed into the GPU 130 for training (\textcircled{4}). This process will be repeated for every training epoch, and the input/output (IO) time cost is negligible.

Computational Storage Buffered System

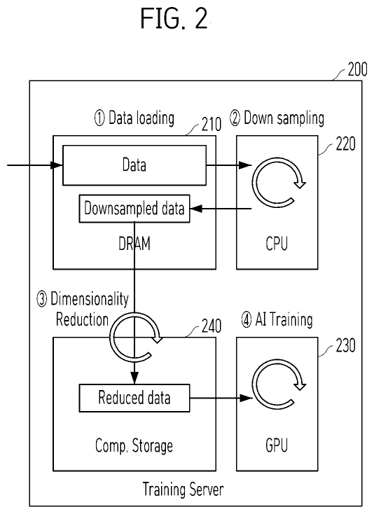

FIG. 2 illustrates a computational storage-buffered training system in accordance with one embodiment of the present disclosure.

Referring to FIG. 2, the inventive training system (or server) 200 may include a DRAM 210, a CPU 220 and a GPU 230. Further, the inventive training system 200 may include a computational (comp.) storage 240 to accelerate data preprocessing using the techniques described below. This inventive training system can minimize data movement in machine learning workloads by performing preprocessing operations near the SSD.

As such, the training system 200 may be implemented with a computational storage, also known as in-situ storage. Computational storage as used herein is a technique that allows data to be stored and processed within a computer's memory, rather than being transferred to and from disk or other external storage devices. The idea of integrating in-memory computing with DNNs has enabled data processing to be performed directly in memory and to significantly reduce the latency and energy consumption of DNN operations. Specifically, computational storage has emerged as a promising solution for accelerating both CNNs and RNNs.

By using custom hardware designs, quantization methods, pruning techniques, and memory access patterns, it is possible to significantly improve the performance of CNN on computational storage devices like FPGAs, enabling the deployment of CNNs on resource-constrained devices and accelerating use of FPGAs in large-scale applications. By leveraging the high parallelism and the energy efficiency of FPGAs, the training process of CNNs has been sped up.

Computational storage has been explored as a potential solution to overcome the computational limitations of traditional CPU and GPU implementations in RNNs. Studies have demonstrated the potential of computational storage, specifically FPGAs, to enable high-performance, low-power, and real-time processing of deep neural networks.

Referring back to FIG. 2, in most cases, reading data from the storage 240 may be relatively slow. Therefore, instead of simply buffering the data on DRAM 210 before training, various embodiments of the present disclosure apply dimensionality reduction (DR) as an inline operation, and the reduced data can be stored in the computational storage 240.

High-dimensional data may contain a large proportion of redundant features, and can increase space and computational time requirements while being prone to overfitting. Dimensionality reduction is an approach that can be leveraged to address such issues. In particular, random projection (RP) is a DR technique that can be used, where the original d-dimensional data is projected to lower, k-dimensional data using a random matrix R whose columns have unit length. RP has shown its potential in feature extraction. One of the advantages of RP is its tangible benefits to counteract the otherwise burdensome computational requirements of processing the higher dimensional data and its ability to meet the needs of real-time processing. RP's simplicity and parallelism enable efficient implementation in FPGAs, which is particularly useful for high-performance computing systems.

To apply dimensionality reduction in the inventive training system, the training server 200 may first load, on the computational storage 240, the original data from a host memory to the working memory (i.e., DRAM 210). In some embodiments, the computational storage 240 may include a computing unit, e.g., a compute unit 300 in FIG. 3. The computing unit may perform a dimensionality reduction (\textcircled{3}) and may store the reduced data in the storage 240. Then, the reduced data may be transferred to GPU 230 for DNN (or AI) training (\textcircled{4}). In some embodiments, the reduced data of the computational storage 240 may be transferred to GPU 230 through a P2P-DMA technique. By applying a dimensionality reduction to the data writing process for buffering, additional data movement and usage of CPU 220 for performing a dimensionality reduction are no longer needed and may be partially or totally eliminated, and memory space on DRAM 210 can be reserved for storing the original data. Additionally, the reduced data may be transmitted to GPU 230, which can reduce both the data transfer time from the storage 240 to GPU 230 and the training time in GPU 230 as it reduces the training model size.

The inventive training system in one embodiment becomes more effective when dealing with relatively larger-dataset DNN training. As described above, instead of exploiting too much of a memory bandwidth of CPU 220, the embodiments of the present disclosure may use the computational storage 240 to perform the dimensionality reduction and may store the reduced-size data for training by GPU 230 (\textcircled{4}). In some embodiments, the computational storage 240 may be utilized by a training batch generator to produce training batches locally, which avoids consuming the host CPU cycles or DRAM bandwidth. As mentioned above, P2P-DMA may enable direct memory access between GPU 230 and the computational storage 240 without using the host DRAM buffer to minimize host intervention during SSD read/write. Thus, the embodiments of the present disclosure can utilize the benefits of the computational storage 240 and relieve the burden on CPU 220.

B. System Implementation Details

Embodiments of the present disclosure may perform RP using an SGEMM kernel with a U200 FPGA from Xilinx Alveo. The kernel may be implemented using Xilinx OpenCL high level synthesis (HLS) programming. Under the HLS development flow, the FPGA may be managed by the Xilinx Runtime (XRT) software, which provides the APIs and drivers to reprogram and communicate with the FPGA from the host. The SGEMM accelerator may include a portion running on the U200 FPGA, and management code using the OpenCL programming running on the host.

SGEMM Kernel Using Xilinx OpenCL HLS

Embodiments of the present disclosure may implement a tiled Single Precision General Matrix Multiply (SGEMM) accelerator function via multiple compute units (CUs). Multiple compute units may compute tiles of an output matrix in parallel. Each compute unit may be implemented with a structure as shown in FIG. 3 for compute unit 300.

Referring to FIG. 3, the SGEMM kernel (i.e., each compute unit 300) may be used to perform RP function by C=AB, where A is original batch data, B is an RP matrix, and C is a result matrix (or output matrix). As shown, each compute unit 300 may include DSP unit 320 to perform matrix multiply-add operation(s) and BRAM blocks 311-313 for storing input/output tiles (sub-arrays of the matrices A, B, and C). As FPGA on-chip memory resources are limited compared to an external memory, full input batch data and matrices may be first transferred to FPGA's external DRAM 210 (e.g., global buffers), and input tiles (sub-arrays) for the batch data and the RP matrix may be loaded to BRAMs 311-312 on the compute unit 300 as needed to perform the matrix multiplication.

In some embodiments, input data and matrices may be double-buffered to overlap the write from external DRAM and the read for computation of the output tile. However, there may be a tradeoff in employing double-buffering, as it comes at the cost of doubling the BRAM requirement of the kernel. As the FPGA on-chip memory is limited, the tile size in one embodiment can be reduced to compensate, resulting in a higher memory bandwidth requirement. For this reason, embodiments of the present disclosure may buffer input A/B tiles, but may not double-buffer the output C tile. The number of A/B tile accesses may scale per-tile with the matrix size while the number of C accesses does not. For large matrices, the performance gain from double-buffering the C output matrix is minimal compared to the associated penalty for reducing tile size. In the illustrated embodiment of FIG. 3, a BRAM block 311 may buffer input A tiles A₀ and A₁, a BRAM block 312 may buffer input B tiles B₀ and B₁, and a BRAM block 313 may buffer an output C tile, which corresponds to the result matrix of the DSP unit 320.

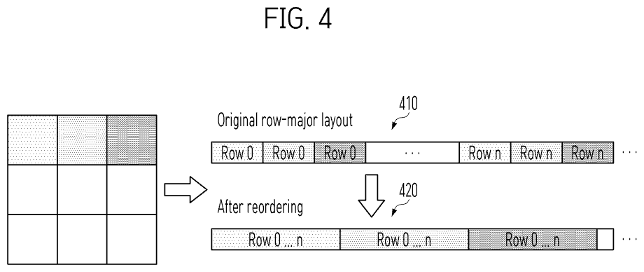

In some embodiments, in order to take advantage of the FPGA's DRAM memory bandwidth, data access pattern is sequential. In one embodiment, Xilinx HLS software may be employed to provide two main optimizations for memory accesses, burst transfers and read/write widening, which use a sequential, regular access pattern. Under a standard row- or column-major matrix layout, tiles may be located in a non-contiguous region of memory, while disabling other possible optimizations. In order to resolve this issue, a host may perform a reordering of input matrices to a tiled data format before transferring to the SGEMM kernel, i.e., the compute unit 300. As shown in FIG. 4, an original row-major layout 410 may be reordered to a data layout 420. The original row-major layout 410 may include data placed in order of row 0 for each input tile, row 1 for each input tile . . . up to row n for each input tile. The data layout 420 may include tiles (submatrices of the matrices) placed in order of row 0 to row n for the first input tile, row 0 to row n for the second input tile . . . up to row 0 to row n for the final input tile, such that under the re-ordered data layout, each tile is in a contiguous region of memory. Accordingly, while applying data reordering incurs a host memory bandwidth overhead, this cost reduces the overall execution time by setting up the FPGA to burst read/write tiles from a contiguous region of memory.

OpenCL Host Application

The host application may provide an API (C++, scikit-learn) for the user to perform matrix-multiplications using the U200 FPGA. Internally, the host application may use OpenCL queues to schedule the I/O and kernel execution. Tiles of the output matrix may be grouped into OpenCL work-items and divided among the CUs to compute the result in parallel.

Because the matrix data originally resides outside the FPGA DRAM (either in host DRAM or in SSD), in practice there is an additional cost of loading data to the FPGA. When considering the latency of a single matrix-multiply operation, this latency depends on both the PCIe transfer and kernel computation latencies. To address this latency, embodiments of the present disclosure may implement an asynchronous API and pipeline the host-FPGA I/O and kernel compute.

P2P-DMA

On a basic input/output system (BIOS) with support for large memory-mapped IO, the U200 FPGA can map its 64 GB of DDR to the host memory space, allowing for P2P-DMA transfer. If data is intended to be read or written to SSD, PCIe bandwidth can be saved by enabling P2P-DMA and transferring data directly between FPGA and SSD, bypassing the buffer in host memory. Embodiments of the present disclosure may use this feature in the output phase to directly write the reduced matrix to the SSD.

DNN Training System with Computational Storage

FIG. 5 illustrates the basic setup for the inventive computational storage-enabled training system. This system may include an object storage server 200a and a training server 200b. In one embodiment, the training server 200b may use GPU 230 and a computational storage 240 that employs the Xilinx Alveo U200 FPGA with a 4 TB SK hynix SSD. This system may support a (1) C++ API or (2) scikit-learn API to apply dimensionality reduction in the computational storage 240 and output the result either to host DRAM 210 (shown in FIG. 2) or to the SSD of the storage server 200b via P2P-DMA.

The overall training tasks may be managed and orchestrated by Apache Airflow as shown in FIG. 5. Training data may be originally stored in Ceph of the storage server 200a (see operation 510 in FIG. 5), may be transferred to the computational storage 240 for buffering and preprocessing (520), and then may be copied to GPU 240 for training (530). To enable DNN services, embodiments may use TensorFlow (a machine learning platform), which uses CUDA (a parallel computing platform and programming model) and cuDNN (a GPU-accelerated library of primitives for deep neural networks) for GPU acceleration, along with an NVIDIA Tesla 100 GPU with 16 GB memory. In one embodiment, the testbed may use a 3.0 GHz 48-core processor with DDR4-2666 192 GB DRAM, along with the P100 GPU and computational storage prototype. In FIG. 5, Ceph represents an open-source software-defined storage program designed to address the block, file and object storage. TensorFlow represents a free and open-source software library for machine learning and artificial intelligence (AT). Scikit-Learn represents a free software machine learning library for the Python programming language. Airflow represents an open-source workflow orchestration and data pipelining software.

Referring to FIGS. 2 and 5, for the general DNN training system using CS, the original data (Training & validation and test data set) may be initially stored in different containers of Ceph in the storage server. The data may be first transferred to DRAM 210 for buffering, then downsampled by CPU 220 and finally go through RP by the computational storage 240 and saved into the computational storage 240. In one embodiment, the downsampling may include image resize, data argumentation and dimension reshape which can reduce the size of the original data. The reduced-size data may be loaded into GPU 230 during the training. For a large scale training task, the original training input data may be too large to fit entirely into DRAM 210. Thus, the training input data may be partitioned and partially buffered in DRAM 210 based on the DRAM size and training batch size. Then, these buffered data may be downsampled by CPU 220 and finally go through RP by CS 240. This process may be repeated to preprocess all the buffered data.

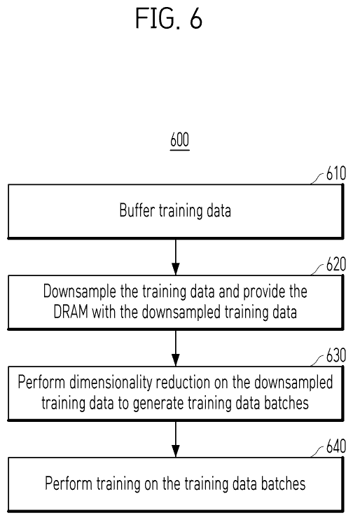

FIG. 6 is a flowchart illustrating an operation 600 of a training system in accordance with one embodiment of the present disclosure. In various embodiments of the present disclosure, the operation 600 may be performed by the training server 200 in FIGS. 2A and 2B, i.e., a dynamic random access memory (DRAM) 210, a central processing unit (CPU) 220 coupled to the DRAM 210, a computational storage 240 coupled to the DRAM 210, and a graphic processing unit (GPU) 230 coupled to the computational storage 240.

Referring to FIG. 6, the operation 600 may include buffering, by the DRAM, training data (610). The operation 600 may include downsampling, by the CPU, the training data to provide the DRAM with the downsampled training data (620). The operation 600 may include performing, by the computational storage, dimensionality reduction on the downsampled training data to generate training data batches (630). The operation 600 may include performing, by the GPU, training on the training data batches (640).

In another embodiment, the dimensionality reduction includes random projection.

In another embodiment, the performing of dimensionality reduction includes providing, by the computational storage, the GPU with the training data batches through a peer-to-peer direct memory access (P2P-DMA).

In another embodiment, the computational storage includes multiple computing units. In one embodiment, the performing of dimensionality reduction by each computing unit includes: storing, buffer blocks, input tiles of the downsampled training data and an output tile of the training data batches; and multiplying and/or adding, by a digital signal processing (DSP) unit, the input tiles to generate the output tile.

In another embodiment, two input tiles are stored in the buffer blocks.

In another embodiment, the input tiles are double-buffered simultaneously by the buffer blocks.

In another embodiment, a data access pattern of the two input tiles is sequential.

In another embodiment, the input tiles have a tiled data format, in which the input tiles are reordered from a row-major layout to a data layout for input matrices.

In another embodiment, the downsampled training data includes data processed through image resize, data argumentation and/or dimension reshape for the training data.

In another embodiment, the buffering of training data includes partitioning the training data and buffering the partitioned training data in the DRAM.

C. Case Study and Experimental Result

This section presents three case studies and experimental results which demonstrate the efficacy of the inventive training system with computational storage compared to other baselines, including a deep learning model with large datasets or datasets having high dimensional data. The performance of different systems were evaluated based on three standards: AI task runtime, training accuracy, and energy cost.

Case Study

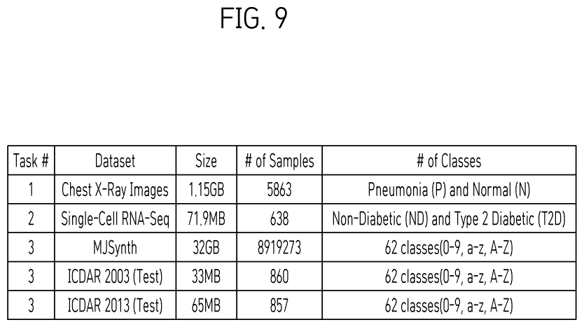

In this work, a general DNN training system was applied to two real-world binary classification tasks using multilayer perceptron (MLP): pediatric pneumonia chest X-ray classification and RNA-seq cell types classification. For the first task, the goal was to differentiate pneumonia and normal chests from chest radiograph images. For the second task, a real transcriptomics dataset from single-cell RNA-seq studies was used, to perform a binary classification of non-diabetic (ND) and Type 2 Diabetic (T2D) cell types for each RNA-seq sample. To demonstrate the performance of the inventive large-dataset DNN training system, an unconstrained scene text recognition task was used, for example, MJSynth, a synthetically generated word image dataset containing 9 million samples, was used for training and validation. ICDAR 2003 and ICDAR 2013] was used as the two test datasets. All five datasets are summarized as shown in FIG. 9.

The MLP model in first two tasks have four neural layers, including three fully connected layers with Relu activation and 0.2 dropouts, and a final layer with 1 neuron and sigmoid activation. A binary cross-entropy was applied for the loss function. In the beginning of task 1, 5 groups of square images with different pixels were used. The entire sample sets were split into training and validation at a ratio of 4:1 for each group. The image data was flattened, and RP was applied to these image samples in the computational storage to reduce the dimension. The number of neurons for each FC layer was set to be the same and equal to the pixel. In task 2, the dimension of the input data was 638×26616. In the preprocessing, the data was split into training and test samples, with 95% and 5% of the data respectively in the training and test samples. The training samples were further split into training and validation samples at a ratio of 3:1. After applying random projection, the number of features in all samples was reduced to 1000. The batch size was changed to show the performance robustness of our system during training.

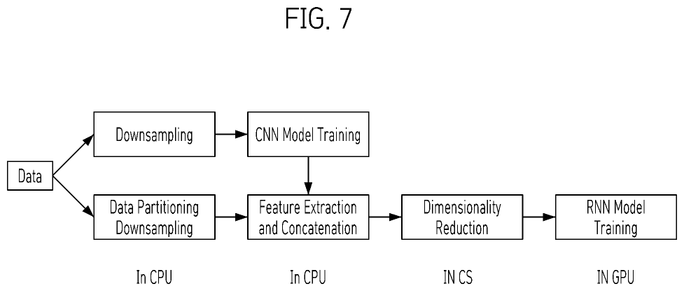

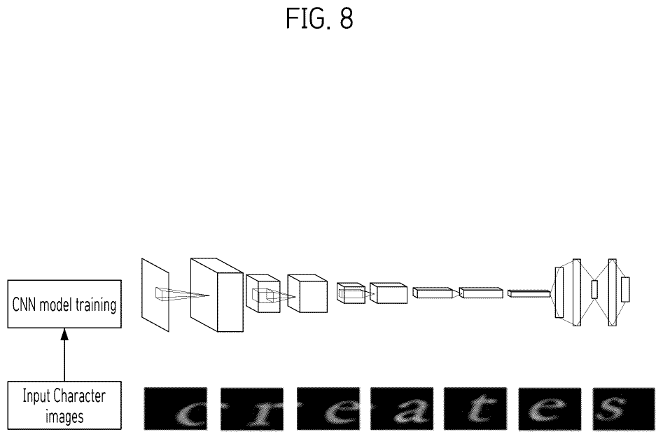

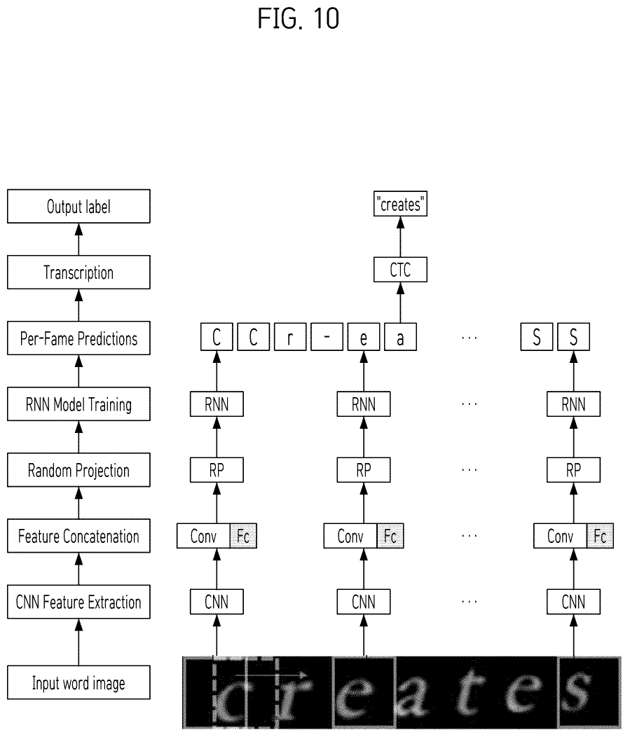

For task 3, CDRNN using the inventive large-dataset CS-based DNN training system was used, whose main workflow is summarized in FIG. 7. To extract robust features for text recognition, this operation first trained a case-sensitive character classifier using 0.1 million images samples (see FIG. 8). These word images are evenly chopped into multiple character images based on the length of the label of each word, in which each character image is given the corresponding label. There were 0.65M input samples used for the CNN training. Second, for each resized word image sample with a given height of 32, a sliding window of size equal to 32 was used to shift the height, and convert the captured image patch to a multi-layer CNN feature sequence by passing the resized word image samples through pre-trained CNN model in CPU. Specifically, the output of the flattened layer and the smallest fully connected layer were extracted, and concatenated into a feature sequence with 552 dimensions. Third, random projection was used to embed the original 552 dimensional feature into a 80 dimensional random subspace in the computational storage. After such an 85% dimensionality reduction, a RNN model was applied to recognize a reduced feature sequence sample in the GPU. The RNN model utilized two bidirectional long short term memory (LSTM) layers with each of 256 nodes. Finally, connectionist temporal classification (CTC) was used to remove the repeated labels and non-character labels in the last output. An Adam optimizer was utilized with a default learning rate. This workflow is presented in FIG. 10. Specifically, a customized training batch generator was used to generate the batch during the training for each system. The original data was partitioned based on the determined batch size to ensure that each partition of data covers one exact batch. During the data partition period, each batch from the DRAM was written into local storage. A conventional CRNN model (as a baseline that uses a storage-buffered DNN training system) was used to compare the training performance. The batch size used in CRNN was made the same as the size of input in the inventive training system. Comparing the inventive CDRNN with the conventional CRNN, the total model size was reduced from 8.7 million parameters to 3.2 million parameters, where the latter was obtained by adding the number of model parameters in CNN and RNN. All systems are tested with three different workloads (0.1M, 1M and 9M images) under a large DNN training environment, indicating that all training data are either buffered in local storage or CS before training, instead of stored in DRAM. For each workload, the training data is split into training and validation at a ratio of 4:1. Note that though the raw size of 9M images dataset in memory is 32 GB, processed data size in memory will increase to 734.4 GB after downsampling, which is far larger than the DRAM size.

### EXPERIMENTAL RESULTS

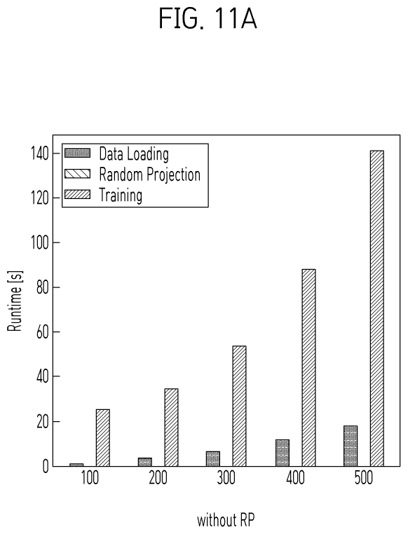

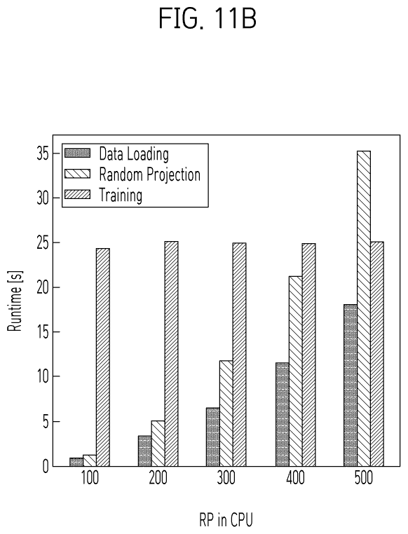

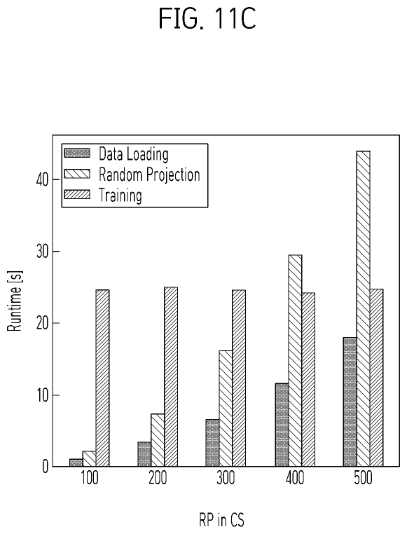

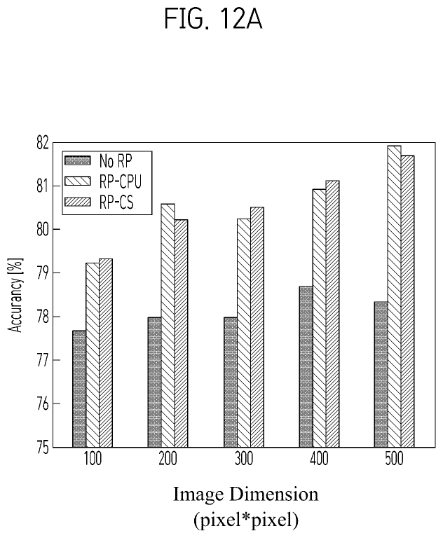

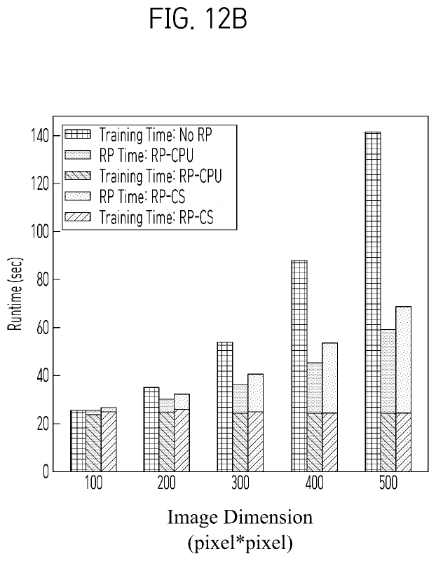

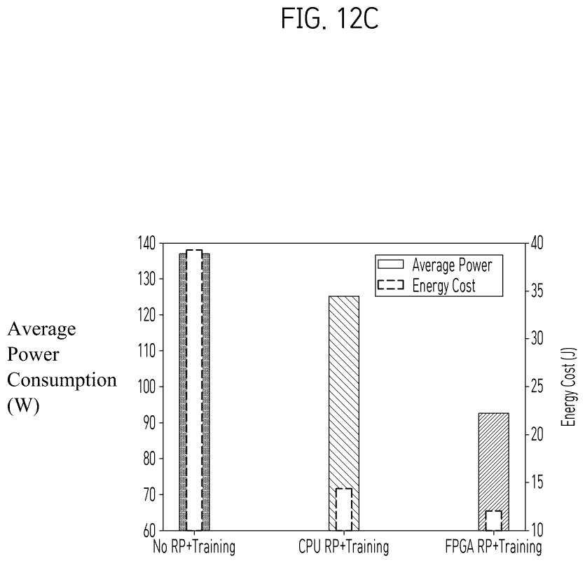

The performance for the different workloads on Task 1 were evaluated. FIGS. 11A to 11C show the runtime of each baseline with different input image sizes. It is evident that the data loading time of all workloads is almost the same with a fixed input image size. With the increase of image size, the runtime of the baseline that has no RP preprocess will increase linearly with the square of pixels. Training times of the two RP-involved systems are almost the same since the reduced feature sizes are similar across different input sizes. The performance was next analyzed for differences among the three systems. As shown in FIG. 12A, the accuracy of the model is relatively higher with a larger input size, as it will keep more features. The systems with RP have an apparent edge over the non-RP ones. According to FIG. 12B, it is noticeable that the RP process can reduce the training time by more than 50%. It can be seen that the increase of training time for non-RP with increasing input size is much larger than the increase of RP time in the RP-involved systems. FIG. 12 shows the average power and total energy consumption collected under input size 500×500 based on the results. Average power and energy consumption measurements exclude the idle power consumed in the background system. Compared to the system without RP and the training time using RP in CPU, the inventive training system can save about 33% and 26% of average power, and further reduce 70% and 16% of total energy consumption, respectively.

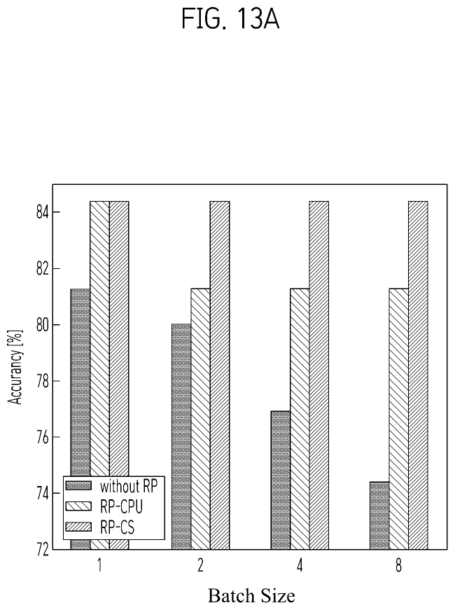

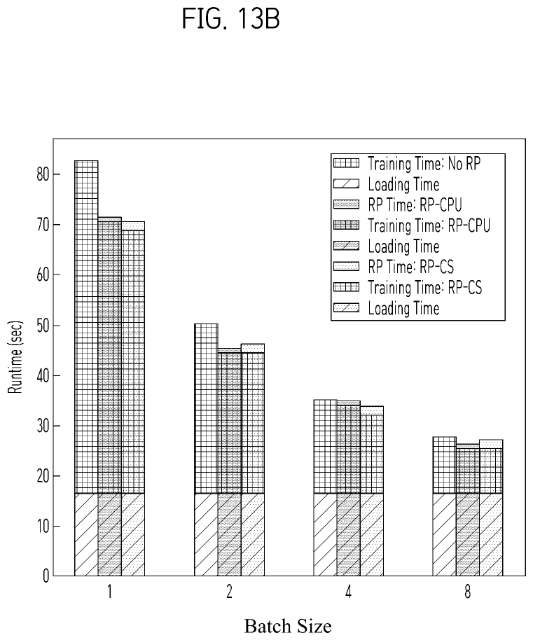

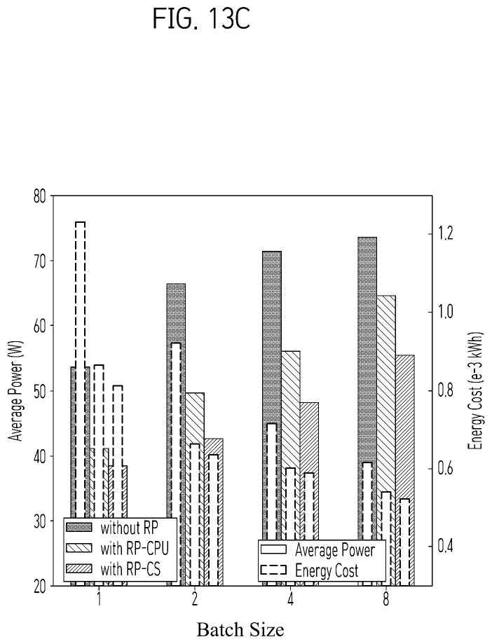

With regard to results from Task 2, as shown in FIG. 13A, the training accuracy decreases significantly with increasing batch size for the systems without RP, but remains almost unchanged for the systems with RP, even with varying batch sizes. As depicted in FIG. 13B, the training time for all systems decreases with increasing batch size. RP-based system has a greater advantage over the non-RP system with smaller batch sizes in terms of training time and end-to-end runtime. The runtime performance between RP-CPU (i.e., RP processing in CPU) and RP-CS (i.e., RP processing in CS) is very similar. Moreover, the data loading time occupied more than half of the total end-to-end runtime when the batch size is over 8. FIG. 13C shows the average power and total energy consumption. Regarding the overall trend, the average power for all system increases with increasing batch size. However, the energy consumption decreases with the increase of batch size. Compared to the system without RP and training time using RP-CPU, by taking the average power and energy values of four different batch sizes, it is worth noting that the inventive training system can save about 30% and 12% of average power, and further reduce 24% and 4% of total energy consumption, respectively.

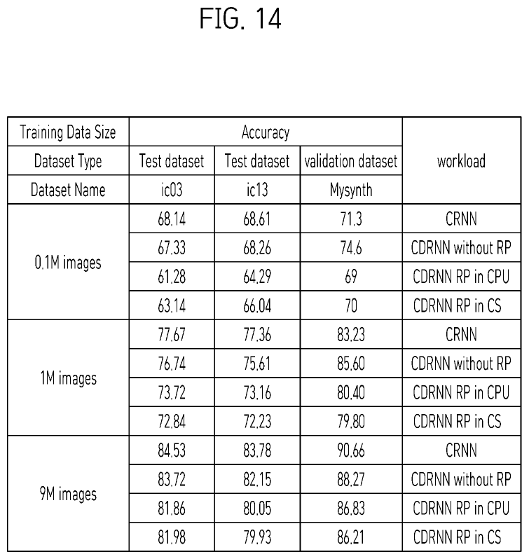

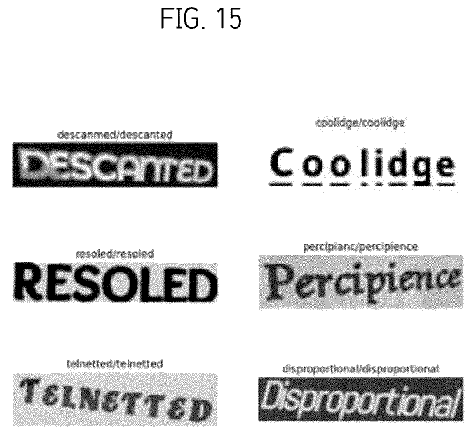

With regard to the performance of each system in Task 3, FIG. 15 shows a demonstration of the test results, where the predicted results are shown on the left caption above each word image, and the ground truths are on its right. FIG. 14 compares the performance of different systems, and reports the training accuracy under four different systems, including inventive CDRNN system when the RP preprocessing is done in CS and CPU. The only difference between the systems is where RP is conducted, including the case where RP is excluded and the original CNN feature is directly fed into the RNN. The best CRNN system was determined in terms of accuracy. However, this advantage narrows with the increasing of dataset size. The accuracy of CDRNN without RP is around 2% higher than the CDRNN with RP due to distortion and information loss in RP. However, the gap narrows greatly with the increase in workload size. The accuracy difference between RP-CPU and RP-CS is negligible and purely due to the randomness of the transformation matrix. When the dataset is small, for all the system, the accuracy on dataset ic13 is higher than that on dataset ic03, as shown in FIG. 14. However, the conclusion becomes the opposite for large datasets.

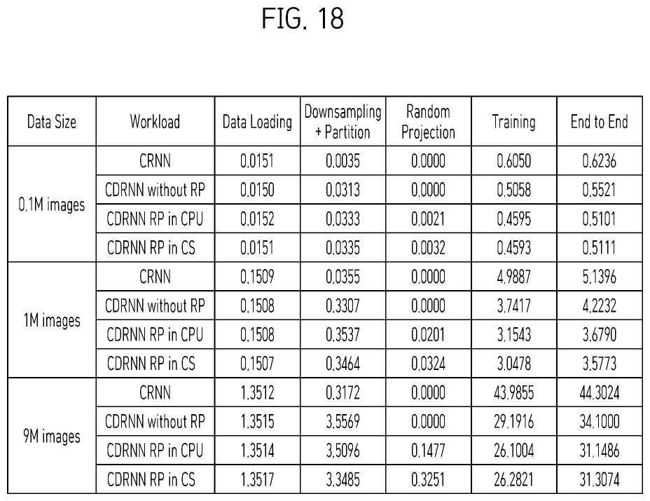

Next, the runtime of each system was examined. The routine used four main phases, including data loading, downsampling and data partitioning, random projection, and training. The end-to-end latency is represented by the sum of the runtime of each phase. The feature extraction step is included into the downsampling step, which consumes a set amount of time for CDRNN-related systems. As shown in FIG. 18, CDRNN with RP significantly outperforms CRNN and is remarkably better than CDRNN without RP across different datasets. Compared to systems CRNN and CDRNN without RP on the 9M dataset (i.e., images), FIG. 18 shows that the inventive training system has a 40.3% and 10% percent training time reduction, respectively, and a 29.3% and 8.2% percent end-to-end latency reduction, respectively.

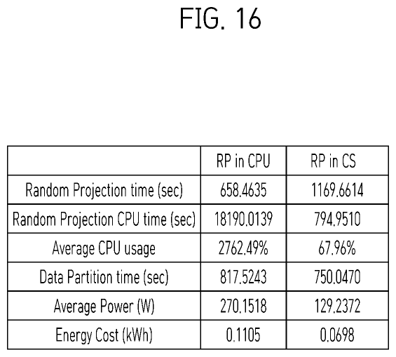

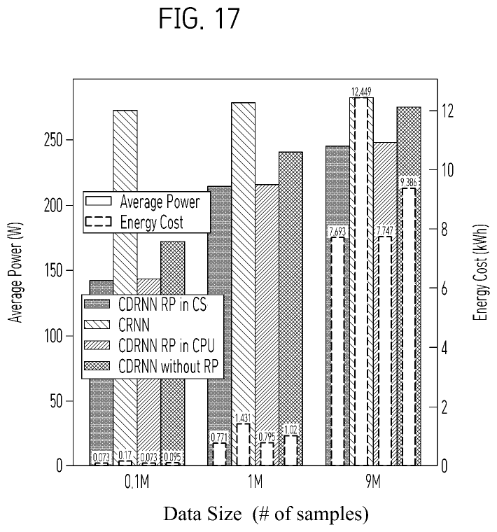

Finally, the average power and total energy consumption were collected under the systems as shown in FIG. 17. Overall, both the average power and energy consumption for all systems increased with the growing dataset size. The results demonstrate the superiority of the inventive CS-based CDRNN system over all other systems. Compared to the CRNN and CDRNN without RP systems, by taking the average power and energy cost on the largest tested dataset, the proposed training system can save about 13.2% and 10.7% of average power, and further reduce 38.2% and 18% of total energy consumption, respectively. Specifically, the inventive training system can save up to 47.7% and 23.5% of average power, and further reduce 57.1% and 17.4% of total energy consumption, respectively. To show the benefit of the inventive CS-based system over RP in the CPU-based system, inventors directly compared the energy consumption and CPU time in RP Phase for the 9M dataset in FIG. 16. The CPU usage of RP-CPU is 40.6 times larger than RP-CS, and the energy cost of RP-CPU is 58.3% larger than RP-CS.

As described above, embodiments of the present disclosure provide a computational storage for an AI training system. Evaluation shows that the computational storage can be used to improve training accuracy and reduce the overall power consumption of a training system.

Although the foregoing embodiments have been illustrated and described in some detail for purposes of clarity and understanding, the present disclosure is not limited to the details provided. There are many alternative ways of implementing the invention, as one skilled in the art would recognize in light of the foregoing disclosure. The disclosed embodiments are thus illustrative, not restrictive. The present disclosure is intended to embrace all modifications and alternatives of the disclosed embodiment(s). Furthermore, the disclosed embodiments may be combined to form additional embodiments.

What is claimed is:

1. A training system comprising:
a dynamic random access memory (DRAM) configured to buffer training data;
a central processing unit (CPU) coupled to the DRAM and configured to downsample the training data and provide the DRAM with the downsampled training data;
a computational storage consisting of a solid-state drive (SSD) and field-programmable gate array (FPGA) and configured to perform dimensionality reduction on the downsampled training data to generate training data batches; and
a graphic processing unit (GPU) configured to perform training on the training data batches.

2. The training system of claim 1, wherein the dimensionality reduction includes random projection.

3. The training system of claim 1, wherein the computational storage provides the GPU with the training data batches through a peer-to-peer direct memory access (P2P-DMA) operation.

4. The training system of claim 1, wherein the computational storage includes multiple computing units, each computing unit including:
buffer blocks configured to store input tiles of the downsampled training data and an output tile of the training data batches; and
a digital signal processing (DSP) unit configured to multiply and add the input tiles to generate the output tile.

5. The training system of claim 4, wherein the buffer blocks store two of the input tiles.

6. The training system of claim 5, wherein the input tiles are double-buffered simultaneously by the buffer blocks.

7. The training system of claim 4, wherein a data access pattern of the two input tiles is sequential.

8. The training system of claim 4, wherein the input tiles have a tiled data format, which are reordered from a row-major layout to a data layout for input matrices where the input tiles are in a contiguous region of memory.

9. The training system of claim 4, wherein the downsampled training data include data processed through image resize, data argumentation and/or dimension reshape for the training data.

10. The training system of claim 4, wherein the training data is partitioned and then buffered in the DRAM.

11. A method for operating a training system, the method comprising:
buffering, by a dynamic random access memory (DRAM), training data;
downsampling, by a central processing unit (CPU) coupled to the DRAM, the training data to provide the DRAM with the downsampled training data;
performing, by a computational storage coupled to the DRAM, dimensionality reduction on the downsampled training data to generate training data batches; and
performing, by a graphic processing unit (GPU), training on the training data batches.

12. The method of claim 11, wherein the dimensionality reduction includes random projection.

13. The method of claim 11, wherein the performing of dimensionality reduction includes providing, by the computational storage, the GPU with the training data batches through a peer-to-peer direct memory access (P2P-DMA) operation.

14. The method of claim 11, wherein the computational storage includes multiple computing units, and
wherein the performing of dimensionality reduction by each computing unit includes:
storing, buffer blocks, input tiles of the downsampled training data and an output tile of the training data batches; and
multiplying and adding, by a digital signal processing (DSP) unit, the input tiles to generate the output tile.

15. The method of claim 14, wherein two of the input tiles are stored in the buffer blocks.

16. The method of claim 15, wherein the input tiles are double-buffered simultaneously by the buffer blocks.

17. The method of claim 14, wherein a data access pattern of the two input tiles is sequential.

18. The method of claim 14, wherein the input tiles have a tiled data format, which are reordered from a row-major data layout to a data layout for input matrices where the input tiles are in a contiguous region of memory.

19. The method of claim 14, wherein the downsampled training data includes data processed through image resize, data argumentation and/or dimension reshape for the training data.

20. The method of claim 14, wherein the buffering of training data includes partitioning the training data and buffering the partitioned training data in the DRAM.
